(19) United States
(12) Patent Application Publication
(10) Pub. No.: US 2026/0360828 A1
(43) Pub. Date: Nov. 12, 2026

(54) METHOD FOR MANUFACTURING ELECTRODE ASSEMBLY FOR SECONDARY BATTERY AND METHOD FOR MANUFACTURING SECONDARY BATTERY INCLUDING SAME

(71) Applicant: SK ON CO., LTD., Seoul (KR)

(72) Inventors: Chang Mook HWANG, Daejeon (KR); Hyun Ji KIM, Daejeon (KR); Jong Hyeok LEE, Daejeon (KR); Yoon Ji JO, Daejeon (KR)

(21) Appl. No.: 19/477,109

(22) PCT Filed: Apr. 19, 2024
(86) PCT No.: PCT/KR2024/005272

§ 371 Date: Oct. 21, 2025

(30) Foreign Application Priority Data
Apr. 21, 2023 (KR) 10-2023-0052595

(51) Int. Cl. H01M 10/0587; H01M 4/02; H01M 4/04; H01M 4/36

(52) U.S. Cl. CPC H01M 10/0587; H01M 4/0404; H01M 4/366; H01M 2004/021

(57) ABSTRACT

In a method for manufacturing an electrode for a secondary battery according to some embodiments, an electrode current collector is prepared. An active material layer including a first region at one end portion and a second region at the other end portion of the electrode current collector having greater active material loading amount and density than the first region is formed to prepare a preliminary electrode. The preliminary electrode is then wound around the one end portion of the electrode current collector together with the active material layer to form a wound electrode including a wound active material layer. Accordingly, the active material density may be maintained substantially uniformly across the entire region of the electrode assembly including the wound electrode, thereby improving cycle life properties.

### TECHNICAL FIELD

The present disclosure relates to a method for manufacturing an electrode assembly for a secondary battery and a method for manufacturing a secondary battery including the electrode assembly for a secondary battery. More specifically, the present disclosure relates to a method for manufacturing an electrode assembly for a secondary battery having active material layers formed on both surfaces of a current collector, and a secondary battery including the electrode assembly for a secondary battery.

### BACKGROUND ART

Secondary batteries are batteries that can be repeatedly charged and discharged. With the development of information and communication and display industries, they have been widely applied as power sources for portable electronic communication devices, such as camcorders, mobile phones, and laptop PCs. In addition, battery packs including secondary batteries have recently been developed and applied as power sources for eco-friendly vehicles, such as electric cars.

Examples of the secondary battery may include a lithium secondary battery, a nickel-cadmium battery, and a nickel-hydrogen battery. Among these, lithium secondary batteries are actively being researched and developed due to their high operating voltage, high energy density per unit weight, and advantages in charging speed and weight reduction.

For example, the lithium secondary battery may include: an electrode assembly including a cathode, an anode, and a separation membrane (separator); and an electrolyte in which the electrode assembly is impregnated. The lithium secondary battery may further include, for example, a pouch-type outer case in which the electrode assembly and the electrolyte are accommodated.

The electrode assembly may have, for example, a jelly-roll shape in which the cathode and the anode are wound with the separation membrane interposed therebetween.

However, in the jelly-roll type electrode assembly, the density of the active material may be uneven due to winding, resulting in non-uniformity in energy density and cycle life properties.

### SUMMARY OF INVENTION

### Problems to be Solved by Invention

An object of the present disclosure is to provide a method for manufacturing an electrode assembly for a secondary battery with improved cycle life properties and energy density.

Another object of the present disclosure is to provide a method for manufacturing a secondary battery including the electrode assembly for a secondary battery.

### Means for Solving Problems

In a method for manufacturing an electrode for a secondary battery according to some embodiments, an electrode current collector may be prepared. An active material layer including a first region at one end portion and a second region at the other end portion of the electrode current collector having greater active material loading amount and density than the first region may be formed on the electrode current collector to prepare a preliminary electrode. The preliminary electrode may then be wound around the one end portion of the electrode current collector together with the active material layer to form a wound electrode including a wound active material layer.

In some embodiments, the active material layer may include an intermediate region formed between the first region and the second region, the intermediate region having greater active material loading amount and density than the first region and lower active material loading amount and density than the second region.

In some embodiments, the active material layer may be formed such that the active material loading amount and density gradually or stepwise increase from the first region to the second region.

In some embodiments, the active material loading amount and density of the wound active material layer may be uniform across the entire region of the electrode current collector.

In some embodiments, the thickness of the active material layer included in the preliminary electrode may be uniform across the entire region of the electrode current collector.

In some embodiments, forming the active material layer may include forming an upper active material layer and a lower active material layer on upper and lower surfaces of the electrode current collector, respectively, and the average active material loading amount and the average density of the lower active material layer may be lower than the average active material loading amount and density of the upper active material layer.

In some embodiments, winding the preliminary electrode may include winding the preliminary electrode with the lower active material layer disposed on an inner side of the winding.

In some embodiments, forming the active material layer may include: forming a first active material layer on a surface of the electrode current collector; and forming a second active material layer on the first active material layer, the second active material layer being spaced apart from the electrode current collector with the first active material layer interposed therebetween.

In some embodiments, the active material loading amount of the first active material layer in the first region may be lower than the active material loading amount of the first active material layer in the second region, and the active material loading amount of the second active material layer in the first region may be greater than the active material loading amount of the second active material layer in the second region.

In some embodiments, the thickness of the first active material layer in the first region may be lower than the thickness of the first active material layer in the second region, and the thickness of the second active material layer in the first region may be greater than the thickness of the second active material layer in the second region.

In some embodiments, the active material loading amount of the first active material layer may gradually or stepwise increase from the first region to the second region, and the active material loading amount of the second active material layer may gradually or stepwise decrease from the first region to the second region.

In some embodiments, forming the first active material layer may include applying a first slurry including a first solvent and the active material, and forming the second active material layer may include applying a second slurry including a second solvent different from the first solvent and the active material to the first active material layer.

In some embodiments, the density of the first solvent may be greater than the density of the second solvent.

In some embodiments, the method may further include arranging the preliminary electrodes on a first surface and a second surface opposite each other of a separation membrane, respectively, and the separation membrane may be wound together with the preliminary electrodes.

In a method for manufacturing a secondary battery according to some embodiments, the electrode assembly manufactured according to the method for manufacturing an electrode assembly for a secondary battery may be prepared. The electrode assembly may be accommodated in a case.

### Advantageous Effects

According to some embodiments, the active material layer of a preliminary electrode prior to winding may be formed so as to have lower active material loading amount and density in a region including the winding center than in a region including the winding end. Accordingly, for example, the wound electrode in a jelly-roll state may have a substantially uniform active material density across its entire region. Therefore, stress generated during a winding operation may be distributed, thereby preventing cracks and delamination of the active material layer. In addition, the energy density and cycle life properties of the secondary battery may be uniform.

According to some embodiments, the active material loading amount and density of the lower active material layer, which is disposed on the inner side during the winding operation, may be reduced during the winding operation. Accordingly, the density of the wound active material layers disposed on the outer and inner sides of the winding may be controlled to be substantially uniform, and cracks and delamination of the electrode due to variations in the active material distribution within the jelly-roll may be prevented. Therefore, the energy density and cycle life properties of the secondary battery may be uniform.

In some embodiments, the active material layer may be formed to include a first active material layer and a second active material layer sequentially formed on the electrode current collector. The active material loading amount of the first active material layer and the second active material layer may gradually or stepwise vary from a first region corresponding to the winding center to a second region corresponding to the winding end. By utilizing a multi-layer structure, the density in the active material layer of the above-described preliminary electrode may be more uniform. Furthermore, by using different solvents in the slurries for forming the first active material layer and the second active material layer, mixing between the active materials and density disturbance between the first active material layer and the second active material layer may be prevented.

The method for an electrode assembly for a secondary battery and the secondary battery manufactured according to the method for manufacturing a secondary battery of the present disclosure may be widely applied in green technology fields, such as electric vehicles, battery charging stations, as well as solar power generation, wind power generation, and the like, which use the batteries. The anode active material for a lithium secondary battery of the present disclosure, the preparation method thereof, and the lithium secondary battery including the same may be used in eco-friendly electric vehicles, hybrid vehicles, and the like, which are aimed at mitigating climate change by reducing air pollution and greenhouse gas emissions.

### BRIEF DESCRIPTION OF DRAWINGS

FIGS. 1 and 2 are views for describing a method for manufacturing an electrode assembly for a secondary battery according to some embodiments.

FIGS. 3 and 4 are schematic cross-sectional views illustrating a preliminary electrode according to some embodiments.

FIG. 5 is a schematic plan view illustrating a secondary battery according to some embodiments.

### MODE FOR CARRYING OUT INVENTION

Embodiments of the present disclosure provide a method for manufacturing an electrode assembly for a secondary battery, which includes winding a preliminary electrode having variations in the loading amount or density of an active material layer in different regions. In addition, a method for manufacturing a secondary battery including the electrode assembly for a secondary battery is provided.

Hereinafter, the embodiments of the present disclosure will be described in more detail with reference to the accompanying drawings. However, the drawings attached to the present disclosure are merely illustrative of some embodiments of the present disclosure to aid in understanding the technical spirit of the invention together with the foregoing description. Therefore, the present disclosure should not be construed as being limited to the matters illustrated in the drawings.

As used herein, the terms “upper portion,” “lower portion,” “upper surface,” “lower surface,” and the like, are used in a relative sense to distinguish the positions of components, and do not specify absolute positions.

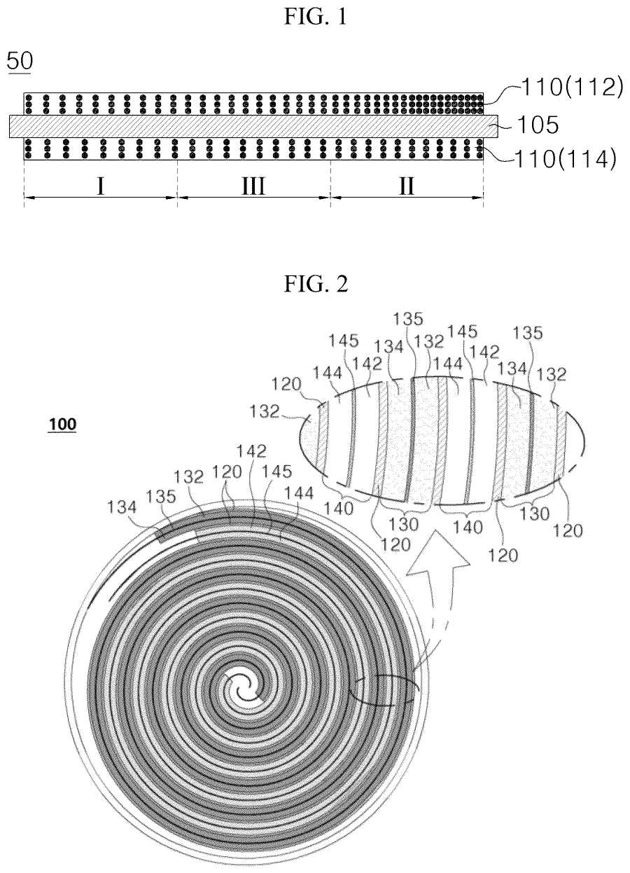

FIGS. 1 and 2 are views for describing a method for manufacturing an electrode assembly for a secondary battery according to some embodiments.

Referring to FIG. 1, an active material layer 110 may be formed on an electrode current collector 105 to form a preliminary electrode 50. The active material layer 110 may include an active material that provides charge/discharge activity to the electrode of the secondary battery. For example, the active material may be dispersed in the form of particles within the active material layer 110, as indicated by the black dots in FIG. 1.

According to some embodiments, the active material layer 110 may be formed such that the active material loading amount and density at one end portion of the electrode current collector 105 are greater than the active material loading amount and density at the other end portion of the electrode current collector 105.

For example, the electrode current collector 105 or the active material layer 110 may include a first region I and a second region II. The first region I may include one end portion of the electrode current collector 105 and may have a predetermined width from one end portion. The second region II may include the other end portion and may have a predetermined width from the other end portion.

According to some embodiments, the first region I may have lower active material loading amount and density than those of the second region II.

In some embodiments, the active material layer 110 may further include an intermediate region III disposed between the first region I and the second region II. The active material loading amount and density of the intermediate region III may be greater than those of the first region I and lower than those of the second region II.

As described above, the active material loading amount and density may increase sequentially from the first region I to the second region II (or from one end portion of the electrode current collector 105 to the other end portion).

In an embodiment, the active material loading amount and density may gradually increase from the first region I to the second region II. In this case, the active material loading amount and density may also gradually increase within the first region I, the second region II, and/or the intermediate region III.

In an embodiment, the active material loading amount and density may stepwise increase from the first region I to the second region II. In this case, the active material loading amount and density may also stepwise increase within the first region I, the second region II, and/or the intermediate region III.

The intermediate region III may serve as, for example, a buffer region and may prevent delamination and cracks of the active material layer 110 during the winding process described below due to abrupt changes in the active material loading amount and density from one end portion to the other end portion of the electrode current collector.

The thickness of the active material layer 110 may be substantially the same from one end portion to the other end portion of the electrode current collector 105. Accordingly, the active material loading amount and the density of the active material layer 110 may be readily controlled by adjusting the amount of active material injected within a set thickness.

According to some embodiments, the active material layer 110 may be formed on upper and lower surfaces of the electrode current collector 105, respectively. For example, the active material layer 110 may include an upper active material layer 112 formed on the upper surface of the electrode current collector 105 and a lower active material layer 114 formed on the lower surface of the electrode current collector 105. As described above, each of the upper active material layer 112 and the lower active material layer 114 may have variations in active material loading amount and density across different regions.

In some embodiments, the average active material loading amount and the average density of the lower active material layer 114 may be lower than the average active material loading amount and the average density of the upper active material layer 112.

The active material layer 110 may be formed by coating a slurry including the active material on the electrode current collector 105, followed by drying and roll-pressing. For example, the slurry may be prepared by mixing the active material with a binder, a conductive material and/or a dispersant in a solvent.

The solvent may be a polar protic solvent, a polar aprotic solvent, or a non-polar solvent.

The polar aprotic solvent may include, for example, N-methyl-2-pyrrolidone (NMP), dimethylformamide (DMF), dimethyl sulfoxide (DMSO), acetonitrile, butylene carbonate, propylene carbonate (PC), dimethyl carbonate (DMC), diethyl carbonate (DEC), ethyl methyl carbonate (EMC), methyl propyl carbonate (MPC), ethylene carbonate (EC), ethyl bromide, tetrahydrofuran (THF), acetone or the like.

The polar protic solvent may include, for example, deionized water, distilled water, ethanol, isopropanol, methanol, n-propanol, t-butanol or the like.

The non-polar solvent may include, for example, hexane, heptane, carbon tetrachloride, benzene, toluene, ethylbenzene, xylene, 1,4-dioxane or the like. These may be used alone or in combination of two or more thereof.

In some embodiments, the preliminary electrode 50 may be a preliminary electrode for a cathode. In this case, the active material included in the preliminary electrode 50 may include a compound capable of reversibly intercalating and deintercalating lithium ions. The active material may include lithium-transition metal composite oxide particles. For example, the lithium-transition metal composite oxide particles may include nickel (Ni), and may further include at least one of cobalt (Co) or manganese (Mn).

For example, the lithium-transition metal composite oxide particles may be represented by Formula 1 below.

LiₓNi_{1-y}M_{y}O_{2+z} [Formula 1]

In Formula 1, x may be in the range of 0.9≤x≤1.1, y may be in the range of 0≤y≤0.7, and z may be in the range of −0.1≤z≤0.1. M may represent one or more elements selected from Na, Mg, Ca, Y, Ti, Zr, Hf, V, Nb, Ta, Cr, Mo, W, Mn, Co, Fe, Cu, Ag, Zn, B, Al, Ga, C, Si, Sn and Sr.

A cathode binder may include, for example, an organic binder such as vinylidene fluoride-hexafluoropropylene copolymer (PVDF-co-HFP), polyvinylidene fluoride (PVDF), polyacrylonitrile, polymethyl methacrylate, and the like, or an aqueous binder such as styrene-butadiene rubber (SBR). The cathode binder may be included together with a thickener such as carboxymethyl cellulose (CMC).

For example, a PVDF-based binder may be used as the cathode binder. In this case, the amount of the binder for forming the cathode active material layer may be reduced and the amount of the cathode active material may be relatively increased, thereby improving the output and capacity of the secondary battery 200.

The cathode current collector 135 may include, for example, stainless steel, nickel, aluminum, titanium, copper, or an alloy thereof. For example, the cathode current collector 135 may include aluminum or an aluminum alloy.

A cathode conductive material may be included to promote electron migration between the active material particles. For example, the cathode conductive material may include carbon-based conductive materials such as graphite, carbon black, graphene, or carbon nanotubes, and/or metal-based conductive materials, including perovskite materials, such as tin, tin oxide, titanium oxide, LaSrCoO₃, and LaSrMnO₃, and the like.

In some embodiments, the preliminary electrode 50 may be a preliminary electrode for an anode. In this case, the active material included in the preliminary electrode 50 may include a compound capable of adsorbing and desorbing lithium ions. For example, the active material may include carbon-based materials such as crystalline carbon, amorphous carbon, carbon composites, and carbon fibers, a lithium alloy, a silicon (Si)-based compound, or tin.

The amorphous carbon may include, for example, hard carbon, coke, or mesophase pitch-based carbon fiber (MPCF). The crystalline carbon may include, for example, graphitic carbon such as natural graphite, artificial graphite, coke, or graphitized MCMB. The elements included in the lithium alloy may include, for example, aluminum, zinc, bismuth, cadmium, antimony, silicon, lead, tin, gallium, indium or the like. The silicon-based compound may include, for example, a silicon-carbon composite oxide, such as silicon oxide (SiOₓ) or silicon carbide (SiC).

An anode binder may include, for example, an aqueous binder such as styrene-butadiene rubber (SBR) to ensure compatibility with a carbon-based active material. The anode binder may be included together with a thickener such as carboxymethyl cellulose (CMC).

The anode current collector 145 may include gold, stainless steel, nickel, aluminum, titanium, copper, or an alloy thereof. For example, the anode current collector 145 may include copper or a copper alloy.

The anode conductive material may include, for example, a carbon-based conductive material such as carbon nanotubes, carbon black, or Super P.

Referring to FIG. 2, the preliminary electrode 50 may be wound to form an electrode assembly 100 including a wound electrode.

According to some embodiments, the preliminary electrode 50 may be wound in a jelly-roll shape, with one end portion serving as a winding center and the other end portion serving as a winding end of the electrode current collector 105.

The other end or the second region II of the active material layer 110 may be stretched while being subjected to a winding tension. Accordingly, active materials distributed at a relatively high loading amount in the second region II may be dispersed or expanded. As a result, the uniformity of the active material distribution across the entire region of the active material layer 110 may be improved.

The electrode assembly 100 may include a wound electrode, and the wound active material layer included in the wound electrode may have a substantially uniform active material loading amount and density.

In some embodiments, as described above, the lower active material layer 114 may be disposed on an inner side of the winding, and the upper active material layer 112 may be disposed on an outer side of the winding. Accordingly, the lower active material layer 114, which has a relatively low active material loading amount, may be subjected to a compressive force, thereby increasing its active material density. The upper active material layer 112, which has a relatively high active material loading amount, may be subjected to a tensile force, thereby decreasing its active material density.

Therefore, substantially uniform active material loading amount and density may be achieved throughout the active material layer in the wound state. Accordingly, delamination of the active material layer and non-uniformities in energy density/cycle life properties due to differences in electrode expansion caused by variations in active material distribution in the electrode assembly 100 may be suppressed.

The wound electrode may include a cathode 130 and an anode 140. In some embodiments, a separation membrane 120 may be placed between the cathode 130 and the anode 140, and the cathode 130 and the anode 140 may be wound together with the separation membrane 120.

The cathode 130 may include a cathode current collector 135, an upper cathode active material layer 132, and a lower cathode active material layer 134 with the cathode current collector 135 interposed therebetween. For example, the lower cathode active material layer 134 may be disposed on the inner side of the winding, and the upper cathode active material layer 132 may be disposed on the outer side of the winding.

The anode 140 may include an anode current collector 145, and an upper anode active material layer 142 and a lower anode active material layer 144 with the anode current collector 145 interposed therebetween. For example, the lower anode active material layer 144 may be disposed on the inner side of the winding, and the upper anode active material layer 142 may be disposed on the outer side of the winding.

The separation membrane 120 may include a porous polymer film made of a polyolefin polymer such as an ethylene homopolymer, propylene homopolymer, ethylene/butene copolymer, ethylene/hexene copolymer, ethylene/methacrylate copolymer. The separation membrane 120 may include a nonwoven fabric made of glass fibers having a high melting point, polyethylene terephthalate fibers, and the like.

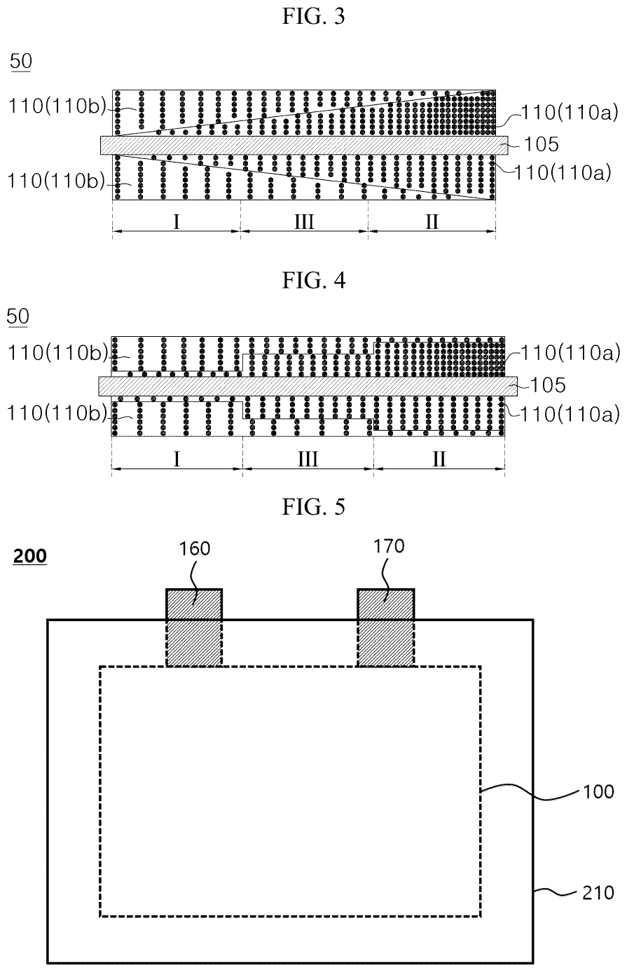

FIGS. 3 and 4 are schematic cross-sectional views illustrating a preliminary electrode according to some embodiments. Detailed descriptions of structures and processes that are substantially the same as or similar to those described with reference to FIGS. 1 and 2 are omitted.

Referring to FIG. 3, a first active material layer 110a may be formed on the electrode current collector 105, and a second active material layer 110b may be formed on the first active material layer 110a to form the active material layer 110 having a multi-layer structure.

For example, the second active material layer 110b may be formed spaced apart from the electrode current collector 105 with the first active material layer 110a interposed therebetween.

According to some embodiments, the active material loading amount of the first active material layer 110a in the first region I of the electrode current collector 105 may be lower than the active material loading amount in the second region II of the electrode current collector 105.

In some embodiments, the active material loading amount of the first active material layer 110a in the intermediate region III may be greater than that in the first region I and lower than that in the second region II. Accordingly, the active material loading amount of the first active material layer 110a may increase sequentially from the first region I to the second region II.

In an embodiment, the active material loading amount of the first active material layer 110a may gradually increase from the first region I to the second region II. In this case, the active material loading amount of the first active material layer 110a may also gradually increase within the first region I, the second region II, and/or the intermediate region III.

According to some embodiments, the active material loading amount of the second active material layer 110b in the first region I of the electrode current collector 105 may be greater than the active material loading amount in the second region II of the electrode current collector 105.

In some embodiments, the active material loading amount of the second active material layer 110b in the intermediate region III may be lower than that in the first region I and greater than that in the second region II. Accordingly, the active material loading amount of the second active material layer 110b may decrease sequentially from the first region I to the second region II.

In an embodiment, the active material loading amount of the second active material layer 110b may gradually decrease from the first region I to the second region II. In this case, the active material loading amount of the second active material layer 110b may also gradually decrease within the first region I, the second region II, and/or the intermediate region III.

In some embodiments, the first active material layer 110a may be formed such that the thickness of the electrode current collector in the first region I is lower than that in the second region II. In this case, the thickness of the first active material layer 110a may gradually increase from the first region I to the second region II.

In some embodiments, the second active material layer 110b may be formed such that the thickness of the electrode current collector 105 in the first region I is greater than the thickness in the second region II. In this case, the thickness of the second active material layer 110b may gradually decrease from the first region I to the second region II.

The thickness increase rate of the first active material layer 110a from the first region I to the second region II may be substantially the same as the thickness decrease rate of the second active material layer 110b from the first region I to the second region II. In this case, the sum of the thickness of the first active material layer 110a and the thickness of the second active material layer 110b may be substantially the same from the first region I to the second region II. Accordingly, excessive variations in the active material loading amounts between the first region I and the second region II due to changes in the thicknesses of the first active material layer 110a and the second active material layer 110b may be suppressed.

In some embodiments, the density of the first active material layer 110a may be increased relative to the density of the second active material layer 110b. In this case, the density of the active material layer 110 may be easily controlled simply by adjusting the thicknesses of the first active material layer 110a and the second active material layer 110b.

According to some embodiments, the active material layer 110 with a multi-layer structure including the first active material layer 110a and the second active material layer 110b may be formed on the upper and lower surfaces of the electrode current collector 105, respectively.

In some embodiments, the first active material layer 110a may be formed by coating a first slurry including an active material on the electrode current collector 105, followed by drying and roll-pressing. For example, the first slurry may be prepared by mixing the active material with a binder, a conductive material and/or a dispersant in a first solvent.

In some embodiments, the second active material layer 110b may be formed by coating a second slurry including an active material on the first active material layer 110a, followed by drying and roll-pressing. For example, the second slurry may be prepared by mixing the active material with a binder, a conductive material and/or a dispersant in a second solvent.

In an embodiment, the active material included in the first slurry may be the same active material as the active material included in the second slurry.

In some embodiments, the first solvent may be a different solvent from the second solvent. For example, the first solvent may have a different polarity from the second solvent.

In an embodiment, the density of the first solvent may be greater than that of the second solvent. Accordingly, the second slurry may be separated and formed on the first slurry due to a difference in density between the first solvent and the second solvent.

In an embodiment, the solubility of the active material in the first solvent may be greater than the solubility of the active material in the second solvent. In this case, the amount of the active material included in the first slurry may be greater than the amount of the active material included in the second slurry. Accordingly, the density of the first active material layer 110a may be greater than that of the second active material layer 110b.

Referring to FIG. 4, the active material loading amount of the first active material layer 110a may stepwise increase from the first region I to the second region II, and the active material loading amount of the second active material layer 110b may stepwise decrease.

FIG. 5 is a schematic plan view illustrating a secondary battery 200 according to some embodiments.

Referring to FIG. 5, the secondary battery 200 may be manufactured by preparing the electrode assembly 100 and accommodating the electrode assembly 100 in an outer case 210.

The electrode assembly 100 may be accommodated in the outer case 210 together with an electrolyte, thereby defining the secondary battery 200. According to some embodiments, a non-aqueous electrolyte may be used as the electrolyte.

The non-aqueous electrolyte may include a lithium salt of an electrolyte and an organic solvent. The lithium salt is represented by, for example, Li⁺X⁻, and as an anion (X⁻) of the lithium salt, F⁻, Cl⁻, Br⁻, I⁻, NO₃⁻, N(CN)₂⁻, BF₄⁻, ClO₄⁻, PF₆⁻, (CF₃)₂PF₄⁻, (CF₃)₃PF₃⁻, (CF₃)₄PF₂⁻, (CF₃)₅PF⁻, (CF₃)₆P⁻, CF₃CF₂SO₃⁻, (CF₃SO₂)₂N⁻, (FSO₂)₂N⁻, CF₃CF₂(CF₃)₂CO⁻, (CF₃SO₂)₂CH⁻, (SF₅)₃C⁻, (CF₃SO₂)₃C⁻, CF₃(CF₂)₇SO₃⁻, CF₃CO₂⁻, CH₃CO₂⁻, SCN⁻ and (CF₃CF₂SO₂)₂N⁻, and the like may be exemplified.

As the organic solvent, for example, propylene carbonate (PC), ethylene carbonate (EC), diethyl carbonate (DEC), dimethyl carbonate (DMC), ethyl methyl carbonate (EMC), methyl propyl carbonate, dipropyl carbonate, dimethylsulfuroxide, acetonitrile, dimethoxyethane, diethoxyethane, vinylene carbonate, sulfolane, gamma-butyrolactone, propylene sulfite and tetrahydrofuran, and the like may be used. These may be used alone or in combination of two or more thereof.

As shown in FIG. 5, electrode tabs may protrude from the electrode current collectors, which belong to each electrode cell, and may extend to one side of the outer case 210. The electrode tabs may be fused together with the one side of the outer case 210 and connected to electrode leads 160 and 170 that extend or are exposed to the outside of the outer case 210.

The lithium secondary battery 200 may be manufactured, for example, in a cylindrical shape using a can, a prismatic shape, a pouch shape or a coin shape.

Hereinafter, experimental examples including specific examples and comparative examples are presented to aid in the understanding of the present invention. However, these examples are provided merely for illustrative purposes of the present invention and are not intended to limit the scope of the appended claims. It will be apparent to those skilled in the art that various changes and modifications may be made within the scope and spirit thereof, and such changes and modifications are to be regarded as falling within the scope of the appended claims.

### Examples and Comparative Examples

### Example 1

### 1) Fabrication of Anode

An anode slurry was prepared by mixing 24% by weight (“wt %”) of natural graphite, 70 wt % of artificial graphite, 1 wt % of carboxymethyl cellulose (CMC), 4 wt % of styrene-butadiene rubber, and 1 wt % of carbon nanotubes (CNTs) as a conductive material in a solvent. The anode slurry was applied to a copper (Cu) foil current collector with an increasing loading amount from the first region to the second region. An anode active material layer was then formed by drying and roll-pressing. Distilled water was used as the solvent.

The loading amount was increased such that the average active material density of a lower anode active material layer formed on the lower surface of the anode active material layer in the first region was 1.4 g/cm³, and the average active material density in the second region was 1.6 g/cm³.

The loading amount was increased such that the average active material density of an upper anode active material layer formed on the upper surface of the anode active material layer in the first region was 1.5 g/cm³, and the average active material density in the second region was 1.7 g/cm³.

### 2) Fabrication of Cathode

A cathode slurry was prepared by mixing LiNi_{0.8}Co_{0.1}Mn_{0.1}O₂ as a cathode active material, carbon black and carbon nanotubes (CNTs) as cathode conductive materials, and polyvinylidene fluoride (PVDF) as a cathode binder in a solvent at a weight ratio of 94:2:4. The cathode slurry was applied to an aluminum (Al) foil current collector with an increasing loading amount from the first region to the second region. A cathode active material layer was then formed by drying and roll-pressing. Distilled water was used as the solvent.

The loading amount was increased such that the average active material density of a lower cathode active material layer formed on the lower surface of the cathode active material layer in the first region was 2.8 g/cm³, and the average active material density in the second region was 3.4 g/cm³.

The loading amount was increased such that the average active material density of an upper cathode active material layer formed on the upper surface of the cathode active material layer in the first region was 3.0 g/cm³, and the average active material density in the second region was 3.7 g/cm³.

### 3) Manufacture of Cylindrical Cell

A polyethylene (PE) separation membrane was interposed between the anode and the cathode. The electrode assembly was then wound so that the outermost portion had a curvature of 2, with the lower surface of the anode active material layer and the lower surface of the cathode active material layer disposed on the inner side of the winding. An electrolyte was then injected to manufacture a cylindrical cell.

### Example 2

### 1) Fabrication of Anode

A first anode slurry was prepared by mixing 24 wt % of natural graphite, 70 wt % of artificial graphite, 1 wt % of carboxymethyl cellulose (CMC), 4 wt % of styrene-butadiene rubber, and 1 wt % of carbon nanotubes (CNTs) as a conductive material in a solvent. The first anode slurry was applied to a copper (Cu) foil current collector with an increasing loading amount from the first region to the second region. A first anode active material layer was formed by drying and roll-pressing. Propylene carbonate (PC) was used as the solvent.

A second anode slurry was prepared by mixing 24 wt % of natural graphite, 70 wt % of artificial graphite, 1 wt % of carboxymethyl cellulose (CMC), 4 wt % of styrene-butadiene rubber (SBR), and 1 wt % of carbon nanotubes (CNTs) as a conductive material in a solvent. The second anode slurry was applied to the first anode active material layer with a decreasing loading amount from the first region to the second region. A second anode active material layer was then formed by drying and roll-pressing. Distilled water was used as the solvent.

The loading was adjusted such that the average density of a first anode active material layer and a second anode active material layer of a lower anode active material layer formed on the lower surface of the anode active material layer in the first region was 1.4 g/cm³, and the active material density in the second region was 1.6 g/cm³.

The loading was adjusted such that the average density of a first anode active material layer and a second anode active material layer of an upper anode active material layer formed on the upper surface of the anode active material layer was 1.5 g/cm³ in the winding start portion, and 1.7 g/cm³ in the winding end portion

### 2) Fabrication of Cathode

A first cathode slurry was prepared by mixing LiNi_{0.8}Co_{0.1}Mn_{0.1}O₂ as a cathode active material, carbon black and carbon nanotubes (CNTs) as cathode conductive materials, and polyvinylidene fluoride (PVDF) as a cathode binder in a solvent at a weight ratio of 94:2:4. The first cathode slurry was applied to an aluminum foil current collector with an increasing loading amount from the first region to the second region. A first cathode active material layer was then formed by drying and roll-pressing. Propylene carbonate (PC) was used as the solvent.

A second cathode slurry was prepared by mixing LiNi_{0.8}Co_{0.1}Mn_{0.1}O₂ as a cathode active material, carbon black and carbon nanotubes (CNTs) as cathode conductive materials, and polyvinylidene fluoride (PVDF) as a cathode binder in a solvent at a weight ratio of 94:2:4. The second cathode slurry was applied to the first cathode active material layer with a decreasing loading amount from the first region to the second region. A second cathode active material layer was then formed by drying and roll-pressing. Distilled water was used as the solvent.

The loading was adjusted such that the average density of a first cathode active material layer and a second cathode active material layer of a lower cathode active material layer formed on the lower surface of the cathode active material layer was 2.8 g/cm³ in the winding start portion, and the average density of the active material was 3.4 g/cm³ in the winding end portion.

The loading was adjusted such that the average densities of the first cathode active material layer and the second cathode active material layer of an upper cathode active material layer formed on the upper surface of the cathode active material layer in the first region were 3.0 g/cm³, and the average density of the active material in the second region was 3.7 g/cm³.

### 3) Manufacture of Cylindrical Cell

A polyethylene (PE) separation membrane was interposed between the anode and the cathode. The electrode assembly was then wound so that the outermost portion had a curvature of 2, with the lower anode active material layer and the lower cathode active material layer disposed on the inner side of the winding. An electrolyte was then injected to manufacture a cylindrical cell.

### Example 3

A cylindrical cell was manufactured in the same manner as in Example 2, except that the outermost portion was set to have a curvature of 1 during the winding.

### Example 4

A cylindrical cell was manufactured in the same manner as in Example 2, except that the outermost portion was set to have a curvature of 3 during the winding.

### Comparative Example 1

### 1) Fabrication of Anode

An anode slurry was prepared by mixing 24 wt % of natural graphite, 70 wt % of artificial graphite, 1 wt % of carboxymethyl cellulose (CMC), 4 wt % of styrene-butadiene rubber, and 1 wt % of carbon nanotubes (CNTs) as a conductive material in distilled water. The anode slurry was applied to a copper (Cu) foil current collector, and then dried and roll-pressed to form an anode active material layer having an active material density of 1.6 g/cm³, thereby fabricating an anode for a secondary battery.

### 2) Manufacture of Cylindrical Cell

Lithium foil was used as a counter electrode, and a polyethylene (PE) separation membrane was interposed between the anode and the counter electrode. The electrode assembly was then wound so that the outermost portion had a curvature of 2. An electrolyte was then injected to manufacture a cylindrical cell.

### Comparative Example 2

A cylindrical cell was manufactured in the same manner as in Comparative Example 1, except that the anode slurry was applied, dried, and roll-pressed such that the anode active material layer had an active material density of 1.7 g/cm³.

### Comparative Example 3

A cylindrical cell was manufactured in the same manner as in Comparative Example 1, except that the anode slurry was applied, dried, and roll-pressed such that the anode active material layer had an active material density of 1.5 g/cm³.

The slurry loading amounts of Examples 1 and 2 are shown in Table 1 below.

TABLE 1

| | | | Loading amount (mg/cm²) | | | | |
|---|---|---|---|---|---|---|---|
| | | | | | | | Winding |
| | | | Winding | ¼ point | | ¾ point | end |
| | | | start | from the | | from the | portion |
| | | | portion | winding | Center of | winding | (the other |
| | Electrode | Slurry | (one end | start | current | start | end |
| | type | type | portion) | portion | collector | portion | portion) |
| Example | Cathode | Lower | 16.0 | 17.5 | 19.0 | 20.5 | 22.0 |
| 1 | | cathode | | | | | |
| | | slurry | | | | | |
| | | Upper | 17.0 | 18.7 | 20.4 | 22.1 | 23.8 |
| | | cathode | | | | | |
| | | slurry | | | | | |
| | Anode | Lower | 6.5 | 7.25 | 8.0 | 8.75 | 9.5 |
| | | anode | | | | | |
| | | slurry | | | | | |
| | | Upper | 7.5 | 8.25 | 9.0 | 9.75 | 10.5 |
| | | anode | | | | | |
| | | slurry | | | | | |
| Example | Cathode | Lower | 0.0 | 5.5 | 11.0 | 16.5 | 22.0 |
| 2 | | first | | | | | |
| | | cathode | | | | | |
| | | slurry | | | | | |
| | | Upper | 1.0 | 6.25 | 11.5 | 16.75 | 22.0 |
| | | first | | | | | |
| | | cathode | | | | | |
| | | slurry | | | | | |
| | | Lower | 16.0 | 12.0 | 8.0 | 4.0 | 0.0 |
| | | second | | | | | |
| | | cathode | | | | | |
| | | slurry | | | | | |
| | | Upper | 16.0 | 12.45 | 8.9 | 5.35 | 1.8 |
| | | second | | | | | |
| | | cathode | | | | | |
| | | slurry | | | | | |
| | Anode | Lower | 0.0 | 2.375 | 4.75 | 7.125 | 9.5 |
| | | first | | | | | |
| | | anode | | | | | |
| | | slurry | | | | | |
| | | Upper | 1.0 | 3.125 | 5.25 | 7.375 | 9.5 |
| | | first | | | | | |
| | | anode | | | | | |
| | | slurry | | | | | |
| | | Lower | 6.5 | 4.875 | 3.25 | 1.625 | 0.0 |
| | | second | | | | | |
| | | anode | | | | | |
| | | slurry | | | | | |
| | | Upper | 6.5 | 5.125 | 3.75 | 2.375 | 1.0 |
| | | second | | | | | |
| | | anode | | | | | |
| | | slurry | | | | | |

### Experimental Example

(1) Measurement of Active Material Density in the Anode Active Material Layer after Winding

After winding, a portion of the cylindrical cell was cut from the outermost portion to the center, and the thickness, length, and width of the electrode were measured using a micrometer, and the active material weight was measured and used to determine the active material density of the active material layer.

### (2) Measurement of Cycle Life Properties

The battery cells according to the examples and comparative examples were subjected to repeated charging (CC-CV 1.0C, 4.2V cut-off) and discharging (1.0C, 2.7V cut-off), and the number of cycles was measured until the discharge capacity reached 60% or less relative to the initial discharge capacity.

The evaluation results are shown in Table 2 below.

TABLE 2

| | Average density of active material (g/cm³) | | | | | |
|---|---|---|---|---|---|---|
| | | | | | Winding | |
| | Winding | ¼ point | | ¾ point | end | |
| | start | from the | | from the | portion | |
| | portion | winding | Center of | winding | (the other | Cycle life |
| | (one end | start | current | start | end | properties |
| | portion) | portion | collector | portion | portion) | (cycles) |
| Example 1 | 1.54 | 1.54 | 1.55 | 1.56 | 1.56 | 1,050 |
| Example 2 | 1.54 | 1.54 | 1.55 | 1.56 | 1.56 | 1,500 |
| Example 3 | 1.52 | 1.53 | 1.55 | 1.57 | 1.58 | 1,400 |
| Example 4 | 1.55 | 1.55 | 1.55 | 1.55 | 1.55 | 1,400 |
| Comparative | 1.31 | 1.39 | 1.47 | 1.51 | 1.59 | 500 |
| Example 1 | | | | | | |
| Comparative | 1.36 | 1.44 | 1.52 | 1.6 | 1.68 | 300 |
| Example 2 | | | | | | |
| Comparative | 1.21 | 1.29 | 1.37 | 1.41 | 1.49 | 700 |
| Example 3 | | | | | | |

Referring to Table 2, in the examples where the density of the active material before winding was gradually increased from the winding start portion (one end portion) to the winding end portion (the other end portion) by varying the loading amount, the density difference after winding was maintained at a small level, resulting in improved cycle life properties.

In Examples 2 to 4 where the active material layers on both surfaces of the current collector were each formed as two-layer structures, the cycle life properties were improved.

In Example 3, where the curvature at the outermost portion during winding was reduced to 1, the energy density slightly decreased.

In Example 4, where the curvature at the outermost portion during winding was increased to 3, the energy density slightly decreased.

In the comparative examples where the density difference between the center and the outer portion of the wound electrode was 0.2 g/cm³ or more without adjusting the loading amount, the energy density was reduced.

1. A method for manufacturing an electrode assembly for a secondary battery comprising:
preparing an electrode current collector;
forming, on the electrode current collector, an active material layer including a first region at one end portion and a second region at the other end portion of the electrode current collector having greater active material loading amount and density than the first region, to form a preliminary electrode; and
winding the preliminary electrode together with the active material layer around the one end portion of the electrode current collector, thereby forming a wound electrode including a wound active material layer.

2. The method for manufacturing an electrode assembly for a secondary battery according to claim 1, wherein the active material layer comprises an intermediate region formed between the first region and the second region, the intermediate region having greater active material loading amount and density than the first region and lower active material loading amount and density than the second region.

3. The method for manufacturing an electrode assembly for a secondary battery according to claim 1, wherein the active material layer is formed such that the active material loading amount and density gradually or stepwise increase from the first region to the second region.

4. The method for manufacturing an electrode assembly for a secondary battery according to claim 1, wherein the active material loading amount and density of the wound active material layer are uniform across the entire region of the electrode current collector.

5. The method for manufacturing an electrode assembly for a secondary battery according to claim 1, wherein the thickness of the active material layer included in the preliminary electrode is uniform across the entire region of the electrode current collector.

6. The method for manufacturing an electrode assembly for a secondary battery according to claim 1, wherein forming the active material layer comprises forming an upper active material layer and a lower active material layer on upper and lower surfaces of the electrode current collector, respectively, and
wherein the average active material loading amount and the average density of the lower active material layer are lower than the average active material loading amount and density of the upper active material layer.

7. The method for manufacturing an electrode assembly for a secondary battery according to claim 6, wherein winding the preliminary electrode comprises winding the preliminary electrode with the lower active material layer disposed on an inner side of the winding.

8. The method for manufacturing an electrode assembly for a secondary battery according to claim 1, wherein forming the active material layer comprises:
forming a first active material layer on a surface of the electrode current collector; and
forming a second active material layer on the first active material layer, the second active material layer being spaced apart from the electrode current collector with the first active material layer interposed therebetween.

9. The method for manufacturing an electrode assembly for a secondary battery according to claim 8, wherein the active material loading amount of the first active material layer in the first region is lower than the active material loading amount of the first active material layer in the second region, and
wherein the active material loading amount of the second active material layer in the first region is greater than the active material loading amount of the second active material layer in the second region.

10. The method for manufacturing an electrode assembly for a secondary battery according to claim 9, wherein the thickness of the first active material layer in the first region is lower than the thickness of the first active material layer in the second region, and
wherein the thickness of the second active material layer in the first region is greater than the thickness of the second active material layer in the second region.

11. The method for manufacturing an electrode assembly for a secondary battery according to claim 9, wherein the active material loading amount of the first active material layer gradually or stepwise increases from the first region to the second region, and
wherein the active material loading amount of the second active material layer gradually or stepwise decreases from the first region to the second region.

12. The method for manufacturing an electrode assembly for a secondary battery according to claim 9, wherein forming the first active material layer comprises applying a first slurry including a first solvent and the active material, and
wherein forming the second active material layer comprises applying a second slurry including a second solvent different from the first solvent and the active material to the first active material layer.

13. The method for manufacturing an electrode assembly for a secondary battery according to claim 12, wherein the density of the first solvent is greater than the density of the second solvent.

14. The method for manufacturing an electrode assembly for a secondary battery according to claim 1, further comprising arranging the preliminary electrodes on a first surface and a second surface opposite each other of a separation membrane, respectively, and
wherein the separation membrane is wound together with the preliminary electrodes.

15. A method for manufacturing a secondary battery comprising:
preparing the electrode assembly manufactured according to claim 1; and
accommodating the electrode assembly in a case.
